(19) United States
(12) Patent Application Publication
(10) Pub. No.: US 2026/0200546 A1
(43) Pub. Date: Jul. 16, 2026

(54) LED PEDALS

(71) Applicant: BRIGHTZ, LTD., Ottawa Lake, MI (US)

(72) Inventors: Samantha VANSICKLE, Canton, MI (US); James MCALLISTER, Perrysburg, OH (US)

(21) Appl. No.: 19/445,975

(22) Filed: Jan. 12, 2026

Related U.S. Application Data
(60) Provisional application No. 63/744,655, filed on Jan. 13, 2025.

(51) Int. Cl. B62J 6/015; F21V 21/08

(52) U.S. Cl. CPC B62J 6/015; F21V 21/08

(57) ABSTRACT

A bike pedal assembly is disclosed that includes a bike pedal and an illumination assembly removably couplable to the bike pedal. The bike pedal includes a first lateral portion defining a first slot and a second lateral portion defining a second slot. The illumination assembly comprises a body and a light source coupled to the body. The body includes a front portion, a first arm extending from a first lateral side of the front portion and extendable through the first slot, and a second arm extending from a second lateral side of the front portion and extendable through the second slot.

### CROSS-REFERENCE TO RELATED APPLICATIONS

This application claims priority to and the benefit of U.S. Provisional Patent Application No. 63/744,655, titled “LED PEDALS” filed on January 13, 2025, the disclosure of which is incorporated by reference in its entirety.

### BACKGROUND

Bicycle (or “bike”) pedals are essential components of a bike that provide the interface between a rider's feet and the bike's drivetrain. While functional for their primary purpose of power transmission, conventional bike pedals lack features that enhance visibility and safety, particularly during low-light conditions such as dawn, dusk, or nighttime riding.

Safety concerns for cyclists have increased as more people use bikes for transportation and recreation in urban environments. Poor visibility of cyclists, especially in low-light conditions, contributes to accidents and safety hazards. While various lighting solutions exist for bikes, including front lights, rear lights, and reflective materials, there remains a need for additional visibility enhancements that are integrated into the bike's existing components.

Accordingly, there exists a need for an improved bike pedal that incorporates lighting functionality while maintaining the structural integrity and performance characteristics required for effective power transmission from the rider to the bike's drivetrain.

### SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a bike pedal assembly comprises a bike pedal and an illumination assembly removably couplable to the bike pedal. The bike pedal includes a first lateral portion defining a first slot and a second lateral portion defining a second slot. The illumination assembly comprises a body and a light source coupled to the body. The body includes a front portion, a first arm extending from a first lateral side of the front portion and extendable through the first slot, and a second arm extending from a second lateral side of the front portion and extendable through the second slot.

In one embodiment, the bike pedal may also include a first flange extending laterally from the first lateral portion and defining a first flange slot; and a second flange extending laterally from the second lateral portion and defining a second flange slot. In one embodiment, the body may further include a first extension extending from the first lateral side of the front portion and alongside the first arm and a second extension extending from the first lateral side of the front portion and alongside the second arm. In one embodiment, the body may further include a first tab extending from the first extension and extendable through the first flange slot and a second tab extending from the second extension and extendable through the second flange slot. In one embodiment, the bike pedal assembly may further include a lens couplable to the body to cover the light source. In one embodiment, the body may define a recess and the illumination assembly may further comprises a power source positionable in the recess and couplable to the light source. In one embodiment, the illumination assembly may further comprise a controller positionable in the recess and couplable to the light source and the power source. In one embodiment, the controller may include a port and the body defines a port aperture aligned with the port. In one embodiment, the controller may include an actuator and the body defines an actuator aperture aligned with the actuator. In one embodiment, the recess may include a first recess defined in the first arm and a second recess defined in the second arm, and the controller may include a first controller portion arranged in the first recess and a second controller portion arranged in the second recess. In one embodiment, the recess may further include a front recess defined in the front portion and that adjoins the first and second recesses. In one embodiment, the illumination assembly may further comprise a cover removably couplable to the body to cover the recess. In one embodiment, the light source may comprise a light emitting diode (LED). In one embodiment, the illumination assembly exhibits a U-shape. In one embodiment, the bike pedal may further include a central portion between the first and second lateral portions and that defines a channel therethrough, and the bike pedal assembly may further include a shaft assembly removably extendable within the channel and couplable a crank arm of a bike.

According to another embodiment consistent with the present disclosure, an illumination assembly comprises a body and a light source coupled to the body. The body includes a front portion, a first arm extending from a first lateral side of the front portion and extendable through a first slot of a bike pedal, and a second arm extending from a second lateral side of the front portion and extendable through a second slot of a bike pedal.

In one embodiment, the body may further include a first extension extending from the first lateral side of the front portion and alongside the first arm, wherein the first tab includes a first tab extendable through a first flange slot of the bike pedal and a second extension extending from the first lateral side of the front portion and alongside the second arm, wherein the second extension includes a second tab extendable through a second flange slot of the bike pedal. In one embodiment, the body may define a recess and the illumination assembly may further comprise a power source positionable in the recess and couplable to the light source and a controller positionable in the recess and couplable to the light source and the power source. In one embodiment, the controller may include a port and the body defines a port aperture aligned with the port and the controller may include an actuator and the body defines an actuator aperture aligned with the actuator. In one embodiment, the recess may include a first recess defined in the first arm and a second recess defined in the second arm, and the controller may include a first controller portion arranged in the first recess and a second controller portion arranged in the second recess.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE FIGURES

FIG. 1 is an isometric view of a bike pedal assembly, in accordance with at least one aspect of the present disclosure.

FIG. 2 is a partial exploded view of the bike pedal assembly of FIG. 1, in accordance with at least one aspect of the present disclosure.

FIG. 3 is an enlarged isometric view of a bike pedal of the bike pedal assembly of FIG. 1 from a front perspective, in accordance with at least one aspect of the present disclosure.

FIG. 4 is an enlarged isometric view of the bike pedal of FIG. 3 from a back perspective, in accordance with at least one aspect of the present disclosure.

FIG. 5 is an enlarged isometric view of a shaft assembly of the bike pedal assembly of FIG. 1, in accordance with at least one aspect of the present disclosure.

FIG. 6 is an exploded view of the shaft assembly of FIG. 5, in accordance with at least one aspect of the present disclosure.

FIG. 7 is an isometric view of an illumination assembly of the bike pedal assembly of FIG. 1 from a front perspective, in accordance with at least one aspect of the present disclosure.

FIG. 8 is the isometric view of the illumination assembly of FIG. 7 omitting a cover and a lens thereof, in accordance with at least one aspect of the present disclosure.

FIG. 9 is an isometric view of the illumination assembly of FIG. 8 from a rear perspective, in accordance with at least one aspect of the present disclosure.

FIG. 10 is a rear view of the illumination assembly of FIG. 8, in accordance with at least one aspect of the present disclosure.

### DETAILED DESCRIPTION OF THE FIGURES

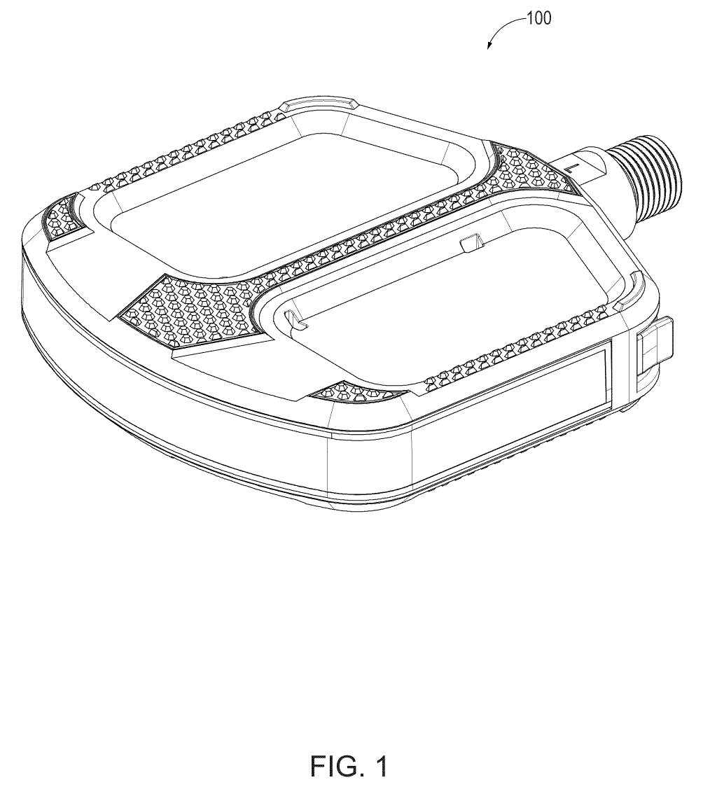

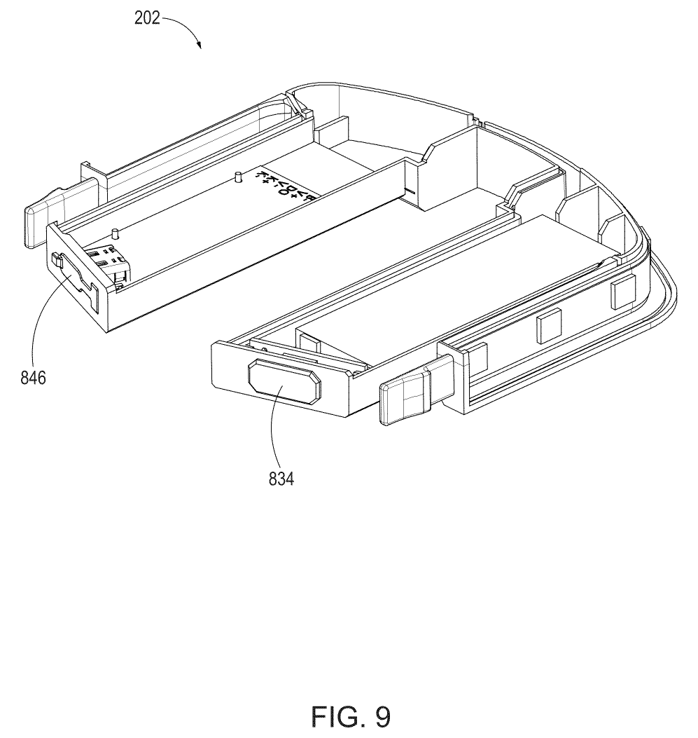

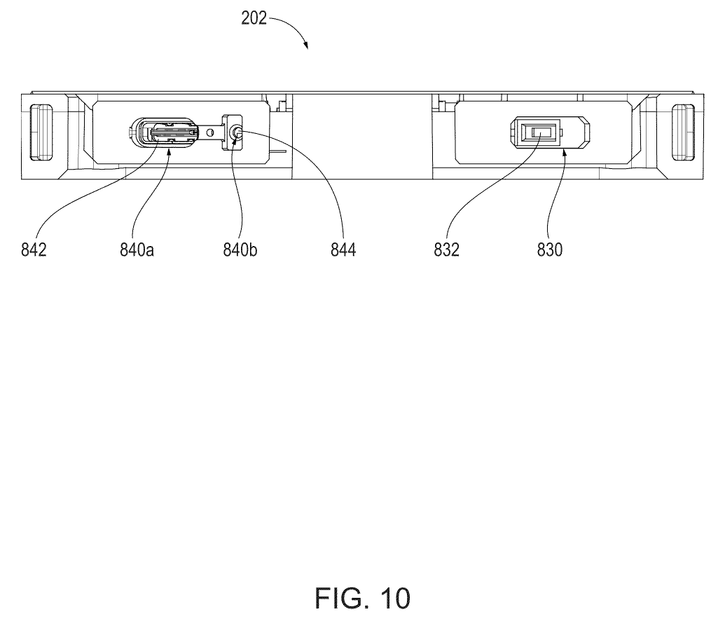

Referring generally to FIGS. 1-10, embodiments of a bike pedal assembly are disclosed. Embodiments disclosed herein provide a modular illuminated pedal system that improves cyclist visibility and safety. In addition, the modular construction enables removal of the illumination assembly for charging without removing the pedals from the bike. In this manner, the bike remains usable while the illumination assembly is charged improving utility and convenience over prior art pedal designs.

FIG. 1 is an isometric view of a bike pedal assembly 100, in accordance with at least one aspect of the present disclosure. While one bike pedal assembly 100 is shown and will be described, the bike pedal assembly 100 may be part of a kit that includes two bike pedal assemblies 100, a first or “right” bike pedal assembly 100 and a second or “left” bike pedal assembly 100, each of which may be coupled, or retrofit, to left and right crank arms (not shown), respectively, of a bike (not shown).

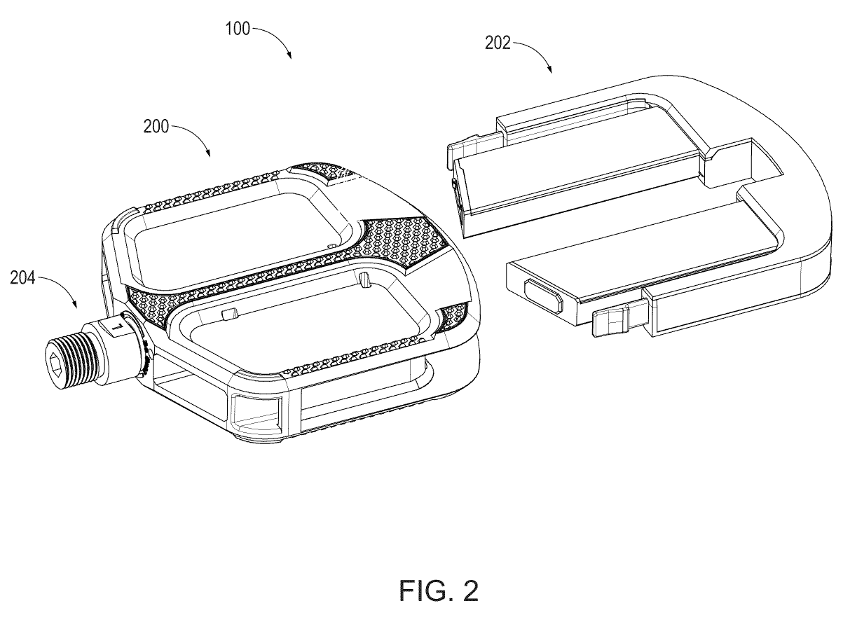

FIG. 2 is a partial exploded view of the bike pedal assembly 100 of FIG. 1, in accordance with at least one aspect of the present disclosure. As shown, the bike pedal assembly 100 may include a bike pedal 200, an illumination assembly or “illumination cartridge” 202, and a shaft assembly 204. As will be described in more detail below, the shaft assembly 204 may be removably coupled to one of the crank arms of the bike and the bike pedal 200, while the illumination assembly 202 may be removably coupled to the bike pedal 200. As used herein, “removably attached” or “removably coupled” means that a first component (e.g., the illumination assembly 202) may be coupled to a second component (e.g., the bike pedal 200) in such a manner that the first and second components can be detached from one another without damaging, or substantially damaging, the structural integrity of one or both of the first and second components, thereby allowing the first and second components to function as intended once detached from one another.

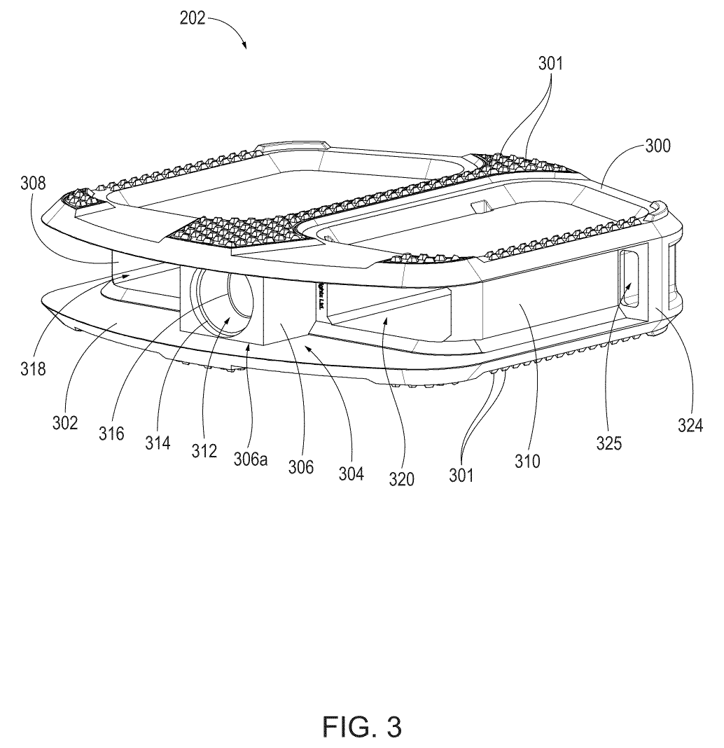

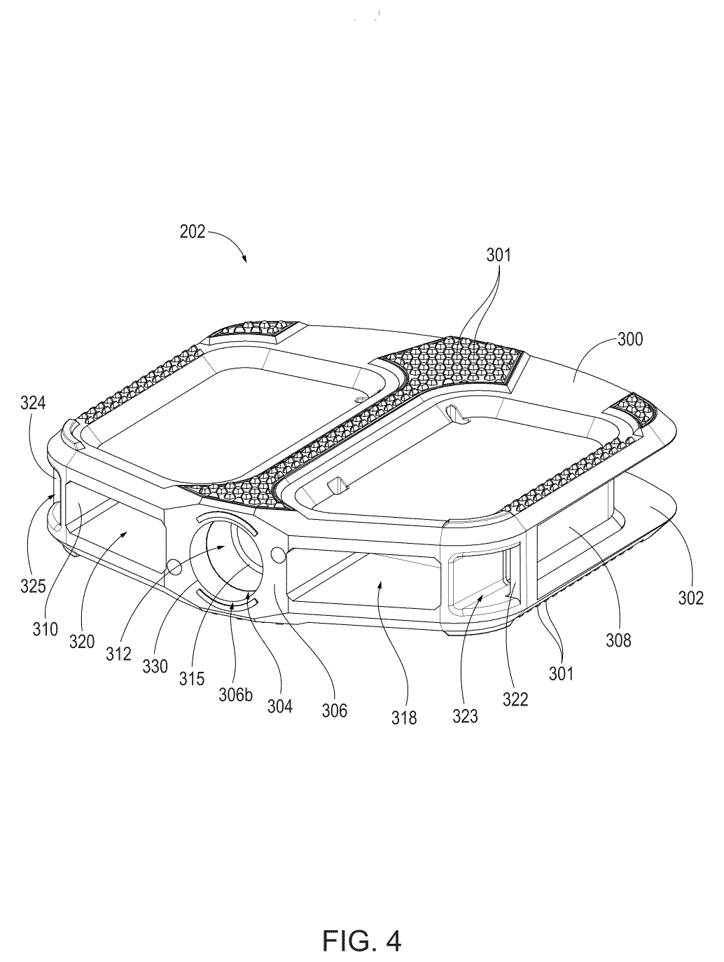

FIG. 3 an enlarged isometric view of the bike pedal 200 of FIG. 2 from a front perspective, in accordance with at least one aspect of the present disclosure. FIG. 4 is an enlarged isometric view of the bike pedal 200 of FIG. 2 from a back perspective, in accordance with at least one aspect of the present disclosure. With reference to FIGS. 3 and 4, the bike pedal 200 may include a first or “top” wall 300, a second or “bottom” wall 302, and a body 304 that interposes (is in between) the first and second walls 300, 302. The first and second walls 300, 302 define, or otherwise provide, a plurality of grips 301 that function to provide traction to the foot of a cyclist when pressed against the first or second wall 300, 302. The bike pedal 200 may be made of a polymer, such as a nylon composite.

The body 304 includes a central portion 306, a first lateral portion 308 extending from a first lateral side of the central portion 306, and a second lateral portion 310 extending from a second lateral side of the central portion 306 opposite the first lateral side. The central portion 306 defines a channel 312 that extends therethrough and that is sized to receive the shaft assembly 204 (FIG. 2). The central portion 306 further defines, or otherwise provides, a first shoulder 314 within the channel 312 located closer to a first or “front” end 306a of the central portion 306 compared to a second or “back” end 306b opposite the first end 306a of the central portion 306. The central portion 306 further provides, or otherwise defines, a second shoulder 315 within the channel 312 located closer to the second end 306b compared to the first end 306a, as well as a third shoulder 316 within the channel 312 located intermediate the first and second shoulders 314, 315. The first lateral portion 308 defines a first slot 318 that extends therethrough and the second lateral portion 310 defines a second slot 320 that extends therethrough.

The body 304 further includes a first flange 322 that extends laterally from the first lateral portion 308 and a second flange 324 that extends laterally from the second lateral portion 310. The first flange 322 defines a first flange slot 323 that extends therethrough and the second flange 324 defines a second flange slot 325 that extends therethrough.

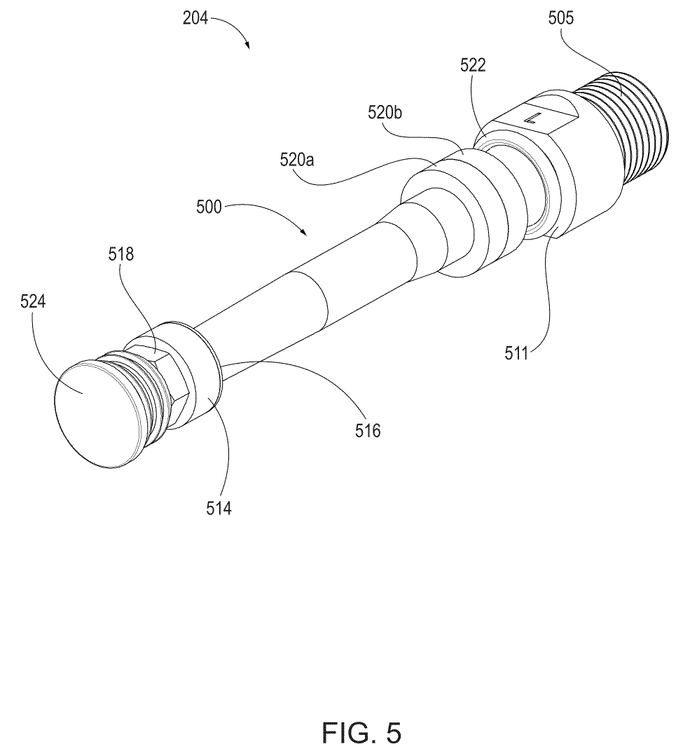

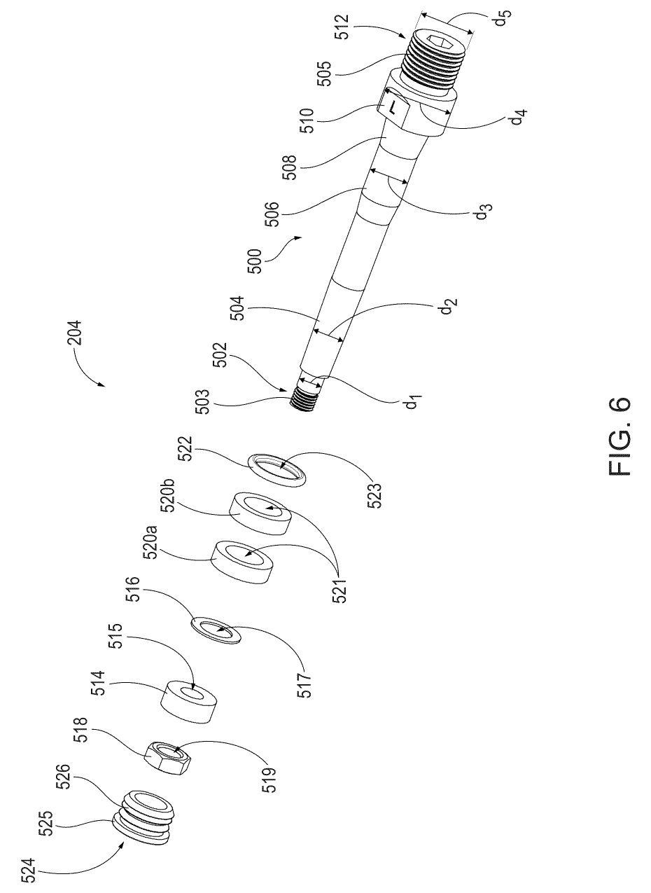

FIG. 5 is an enlarged isometric view of the shaft assembly 204 of FIG. 2, in accordance with at least one aspect of the present disclosure. FIG. 6 is an exploded view of the shaft assembly 204, in accordance with at least one aspect of the present disclosure. With reference to FIGS. 5 and 6, the shaft assembly 204 includes a tapered shaft 500 that includes a first or “front” portion 502 that exhibits a first diameter d₁, a second portion 504 extending from the first portion 502 and that exhibits a second diameter d₂ different (greater) than the first diameter d₁, a third portion 506 extending (flaring) from the second portion 504 and that exhibits a third diameter d₃ different (greater) that the second diameter d₂, a fourth or “tapered” portion 508 that extends and flared outward from the third portion 506, a fifth portion 510 extending from the fourth portion 508 and that exhibits a fourth diameter d₄ different (greater) than the third diameter d₃, and a sixth or “back” portion 512 that extends from the fifth portion 510 and that exhibits a fifth diameter d₅ that is different (less) than the fourth diameter d₄ and different (greater) than the third diameter d₃. In some embodiments, the third and fifth diameters d₃, d₅ may be the same. The first portion 502 defines, or otherwise provides, first threads 503 and the sixth portion 512 defines, or otherwise provides, second threads 505 for threadably coupling with threads (not shown) provided by one of the crank arms of the bike. In some embodiments, the second threads 505 are 9/16^{th} inch size threads. In other embodiments, the second threads are greater than 9/16^{th} inch size threads or less than 9/16^{th} inch size threads.

The shaft assembly 204 further includes a first bearing 514 defining a first bearing aperture 515 that exhibits a diameter that is the same, or substantially the same, as the second diameter d₂, a washer 516 that defines a washer aperture 517 that exhibits a diameter that is the same, or substantially the same, as the second diameter d₂, a nut 518 that defines threads 519 for threadably coupling with the first threads 503, second bearings 520a, 520b that each define a second bearing aperture 521 that exhibits a diameter that is the same, or substantially the same, as the third diameter d₃, an O-ring 522 that defines an O-ring aperture 523 that exhibits a diameter that is greater than the third diameter d₃, and a cap 524 that defines a lip 525 and a plurality of ribs 526. While two second bearings 520a, 520b are shown and described, the shaft assembly 204 may only include one of the second bearings 520a, 520b.

An example operation of coupling the shaft assembly 204 to the bike pedal 200 will now be described. First, the second bearings 520a,b may be inserted into the channel 312 through the back end 306b until the second bearing 520a contacts the second shoulder 315 and the second bearing 520b contacts the second bearing 520a. Then, the first portion 502 of the shaft 500 may be inserted through the O-ring aperture 523 until the O-ring 522 engages a front face 511 (FIG. 5) of the fifth portion 510. Next, the first portion 502 of the shaft 500 may be inserted into the channel 312 through the back end 306b, through the second bearing apertures 521, and further through the channel 312 until O-ring 522 engages a rim 330 (FIG. 4) of the central portion 306 at the back end 306b, thereby defining a first or “rear” seal to prevent debris from entering the channel 312 through the back end 306b.

With the shaft 500 inserted into the channel 312, as described above, the second bearings 520a,b may be axially restrained on the third portion 508 of the shaft 500. More specifically, the second shoulder 315 may prevent the second bearings 520a,b from moving axially along the shaft 500 toward the first portion 502 and the tapered portion 508, due to its increasing (flaring) diameter, may prevent the second bearings 520a,b from moving axially along the shaft 500 toward the rear portion 512.

With the shaft 500 inserted into the channel 312, as described above, the front portion 502 of the shaft 500 extends beyond the third shoulder 316 and near the front end 306a of the channel 312. With the shaft 500 in this position, the washer 516 may be inserted into the channel 312 through the front end 306a and the shaft 500 may extend through the washer aperture 517 until the washer 516 contacts the third shoulder 316. Next, the first bearing 514 may be inserted into the channel 312 through the front end 306a and the shaft 500 may extend through the first bearing aperture 515 until the first bearing 514 contacts the washer 516. Next, the nut 518 may be inserted into the channel 312 through the front end 306a and rotated relative to the shaft 500 (e.g., clockwise) to threadably couple the nut 518 to the first portion 502 via the threads 503, 519. Finally, the cap 524 may be inserted into the channel 312 through the front end 306a until the lip 525 engages the first shoulder 314. When inserted, the ribs 526 may form a frictional interface with the central portion 306 to prevent the cap 524 from falling out of the channel 312. In addition, when inserted, the cap 524 and the central portion 306 may define a second or “front” seal to prevent debris from entering the channel 312 through the front end 306a.

Accordingly, removably coupling the shaft assembly 214 to the bike pedal 200, such as described above, allows the bike pedal 200 to rotate relative to the shaft 500 by way of the bearings 514, 520a,b.

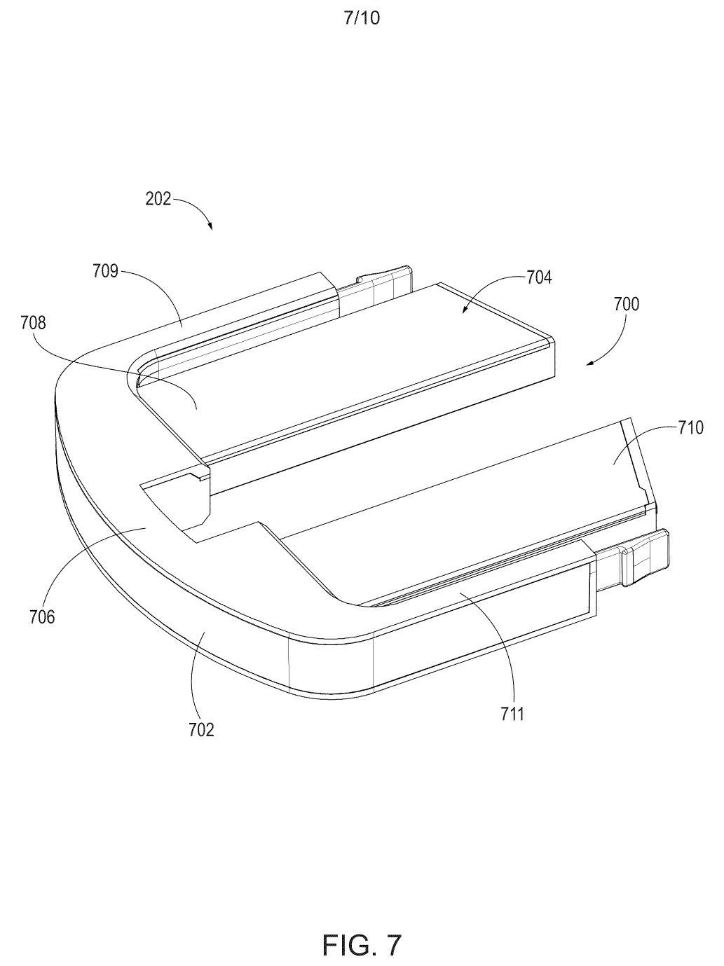

FIG. 7 is an enlarged isometric view of the illumination assembly 202 from a front perspective, in accordance with at least one aspect of the present disclosure. The illumination assembly 202 includes a body 700, a lens 702 removably coupled to the body 700, and a cover 704 removably coupled to the body 700. The lens 702 may be made of a polymer, such polyurethane (PU) or polypropylene (PP), and may optically diffusive. The cover 704 includes a front cover 706, a first lateral cover 708 extending from a first lateral side of the front cover 706, a first tab cover 709 extending from the first lateral side of the front cover 706 alongside the first lateral cover 708, a second lateral cover 710 extending from a second lateral side of the front cover 706 opposite the first lateral side, and a second tab cover 711 extending from the second lateral side of the front cover 706 alongside the second lateral cover 710. The body 700 and the cover 704 may be made of a polymer, such as a nylon composite or Acrylonitrile Butadiene Styrene (ABS). The body 700, the lens 702, and the cover 704 may all generally exhibit a “U” shape. The body 700 and the cover 704 may each also generally exhibit a “fork” shape that includes four prongs, each cover portion 708-711 serving as one of the prongs.

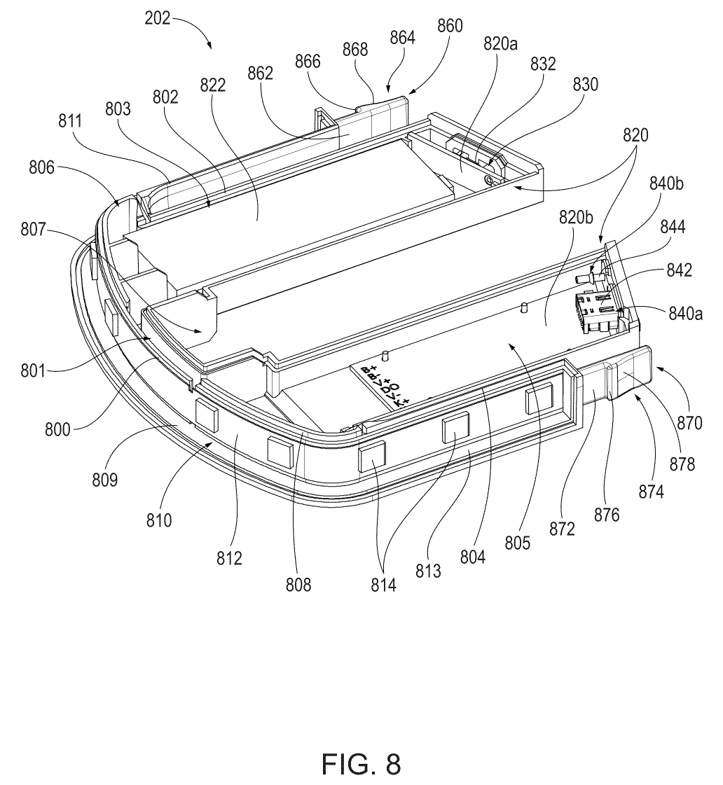

FIG. 8 is the isometric view of the illumination assembly 202 of FIG. 7 omitting the lens 702 and the cover 704 to enable viewing of additional components of the illumination assembly 202. The body 700 includes a front portion 800, a first arm 802 extending from a first lateral side of the front portion 800, and a second arm 804 extending from a second lateral side of the front portion 800 opposite the first lateral side. The front portion 800 defines a front recess 801, the first arm 802 defines a first recess 803 adjoined to the front recess 801, and the second arm 804 defines a second recess 805 adjoined to the front recess 801. When the cover 704 is coupled to the body 700, the front cover 706 covers (occludes) the front recess 801, the first lateral cover 708 covers (occludes) the first recess 803, and the second lateral cover 710 covers (occludes) the second recess 805. The front, first, and second recesses 801, 803, 805 may co-operatively define a recess 806 of the body 700. The front portion 800 and the first and second arms 802, 804 may further define a receiving recess 807 for receiving the central portion 306 of the body 304, as will be described in more detail below. The body 700 further includes a first extension 811 extending from the first lateral side of the front portion 800 alongside the first arm 802 and a second extension 813 extending from the second lateral side of the front portion 800 alongside the second arm 804.

The body 700 further includes an arcuate face 808 that extends along the first extension 811, the front portion 800, and the second extension 813 and a ledge 809 that extends from the arcuate face 808. The illumination assembly 202 further includes a light source 810 that is couplable to the arcuate face 808 and that may be supported by (sit upon) the ledge 809. With the cover 706 coupled to the body 700, the cover 706, the arcuate face 808, and the ledge 809 co-operatively define a recess for receiving the light source 810. The light source 810 may include a strip 812 that includes an adhesive (not shown) for adhering the light source 810 to the arcuate face 808 and a plurality of lights 814 that may be coupled to and positioned (arranged) along the strip 812. In some embodiments, the lights 814 are light emitting diodes (LEDs). The LEDs may be RBG LEDs. The LEDs may be surface mount device (SMD) LEDs or chip-on-board (COB) LEDs. As illustrated, the light source 810 may include ten lights 814, but may, in other embodiments, include less than ten lights 814 (e.g., four, six, or eight lights 814) or more than ten lights 814 (e.g., twelve, fourteen, or sixteen lights 814). The lens 702 may be removably coupled to the body 700, such as press fit thereto, and may be supported by (sit upon) the ledge 809 to cover and protect the light source 810 and optically diffuse light emitted by the lights 814.

The illumination assembly 202 further includes a controller 820 that includes first controller portion 820a arranged within the first recess 803 and a second controller portion 820b arranged within the second recess 805. The first and second controller portions 820a, 820b may be microprocessors or printed circuit boards (PCBs) and may be in operable communication with one another, such as wirelessly or via wires (not shown) that extend between the first and second recesses 803, 805 via the front recess 801. The illumination assembly 202 further includes a power source 822, such as a battery, arranged in the first recess 803 and that is operable to provide power to the light source 810 and the first and second controller portions 820a, 820b. In some embodiments, the power source 822 is a 502060 LiPo 600mAh battery.

The controller 820 may be in operable communication with the light source 810 and operable to control the same. For instance, the controller 820 may be operable to transition the light source 810 between a plurality of states that includes a first or “off” state in which the lights 814 abstain from emitting light, a second or “solid” state in which each of the lights 814 emits a single solid color, and a third or “morph” state in which each of the lights 814 morphs (changes) the color that is emitted therefrom over time. With reference to FIGS. 8, 9, and 10, the first arm 802 may define an actuator aperture 830 and the first controller portion 820a includes an actuator 832, such as a depressible button, that is aligned with and/or extends through the aperture 830 and is actuatable by a user to transition the light source 810 between the plurality of states. The illumination assembly 202 further includes a button cover 834 that is couplable to the first arm 802 and is operable to cover (occlude) the aperture 830 and the actuator 832.

With continued reference to FIGS. 8-10, the second arm 804 may define a first or “port” aperture 840a and a second or “indicator” aperture 840b laterally offset from the first aperture 840a. The second controller portion 820b may include a port 842, such as a USB port, that is aligned with and/or extends through the first aperture 840a and an indicator 844, such as an LED, that is aligned with and/or extends through the second aperture 840b. A plug (not shown), such as a USB plug, may be coupled to the port 842 to charge the power source 822 and/or to operably communicate with the controller 820 to provide software updates thereto.

The indicator 844 may provide a visual cue regarding a status of the illumination assembly 202. As one example, with the plug coupled to the port 842, the second controller portion 820b may cause the indicator 844 to pulse a light (a first state) to provide a visual cue to the user that the power source 822 is not fully charged or cause the indicator 844 to emit a solid light (a second state different than the first state) to provide a visual cue to the user than the power source 822 is fully charged. As another example, with the plug coupled to the port 842, the second controller portion 820b may cause the indicator 844 to pulse a light (a first state) to provide a visual cue to the user that a software update to the controller 820 is in progress and, thus, the plug should not be removed from the port 842, or cause the indicator 844 to emit a solid light (a second state different than the first state) to provide a visual cue to the user than the software update to the controller 820 is complete and that the plug can be removed from the port 842. The illumination assembly 202 further includes a port cover 846 that is couplable to the second arm 804 and is operable to cover (occlude) the first and second apertures 840a,b, the port 842, and the indicator 844.

The body 700 further includes a first tab 860 that includes a first portion 862 extending from the first extension 811 and a second portion 864 extending from the first portion 862. The first portion 862 may be flexible to allow the second portion 864 to rotate relative to the first extension 811. The second portion 864 may include a wall 866 extending transversely (orthogonally) from the first portion 862 and a cam surface 868 extending and tapering from the wall 866. Similarly, the body 700 further includes a second tab 870 that includes a first portion 872 extending from the second extension 813 and a second portion 874 extending from the first portion 872. The first portion 872 may be flexible to allow the second portion 874 to rotate relative to the second extension 813. The second portion 874 may include a wall 876 extending transversely (orthogonally) from the first portion 872 and a cam surface 878 extending and tapering from the wall 876.

An example operation of coupling the illumination assembly 202 to the bike pedal 200 will now be described. As shown with the arrows in FIG. 2, the illumination assembly 202 may aligned and moved longitudinally toward the bike pedal 200. Doing so, the first arm 802 may extend through the first slot 318, the second arm 804 may extend through the second slot 320, and the receiving recess 807 of the front portion 800 may receive the front end 306a of the central portion 306, thereby covering (occluding) the channel 312 from the front end 306a.

At substantially the same time, the cam surface 868 of the first tab 860 may engage the first flange 322 and cause the second portion 864 to flex relative to the first extension 811 as the first tab 860 passes through the first flange slot 323, while the cam surface 878 of the second tab 870 may engage the second flange 324 and cause the second portion 874 to flex relative to the second extension 813 as the second tab 870 passes through the second flange slot 325. After the second portions 864, 874 of the first and second tabs 860, 870 pass through the first and second flange slots 323, 325, respectively, the first and second tabs 860, 870 may naturally bias to their unflexed states (as shown in FIG. 8), at which time the walls 866, 876 of the first and second tabs 860, 870 may contact the first and second flanges 322, 324, respectively, should a user attempt to remove the illumination assembly 202 from the bike pedal 200. To remove the illumination assembly 202 from the bike pedal 200, the user may physically depress the first and second cam surfaces 868, 878 to flex the first and second tabs 860, 870 toward one another, thereby allowing the same to pass through the first and second flange slots 323, 325, respectively, to decouple the illumination assembly 202 from the bike pedal 200.

While this invention has been shown and described with respect to a detailed embodiment or embodiments thereof, it will be understood by those skilled in the art that changes in form and detail thereof may be made without departing from the scope of the claims of the invention.

What is claimed is:

1. A bike pedal assembly, comprising:
a bike pedal, including:
a first lateral portion defining a first slot; and
a second lateral portion defining a second slot; and
an illumination assembly removably couplable to the bike pedal, wherein the illumination assembly comprises:
a body, including:
a front portion;
a first arm extending from a first lateral side of the front portion and extendable through the first slot; and
a second arm extending from a second lateral side of the front portion and extendable through the second slot; and
a light source coupled to the body.

2. The bike pedal assembly of claim 1, wherein the bike pedal further includes:
a first flange extending laterally from the first lateral portion and defining a first flange slot; and
a second flange extending laterally from the second lateral portion and defining a second flange slot.

3. The bike pedal assembly of claim 2, wherein the body further includes:
a first extension extending from the first lateral side of the front portion and alongside the first arm; and
a second extension extending from the first lateral side of the front portion and alongside the second arm.

4. The bike pedal assembly of claim 3, wherein the body further includes:
a first tab extending from the first extension and extendable through the first flange slot; and
a second tab extending from the second extension and extendable through the second flange slot.

5. The bike pedal assembly of claim 1, further comprising a lens couplable to the body to cover the light source.

6. The bike pedal assembly of claim 1, wherein the body defines a recess and the illumination assembly further comprises a power source positionable in the recess and couplable to the light source.

7. The bike pedal assembly of claim 6, wherein the illumination assembly further comprises a controller positionable in the recess and couplable to the light source and the power source.

8. The bike pedal assembly of claim 7, wherein the controller includes a port and the body defines a port aperture aligned with the port.

9. The bike pedal assembly of claim 7, wherein the controller includes an actuator and the body defines an actuator aperture aligned with the actuator.

10. The bike pedal assembly of claim 7, wherein the recess includes a first recess defined in the first arm and a second recess defined in the second arm, and wherein the controller includes a first controller portion arranged in the first recess and a second controller portion arranged in the second recess.

11. The bike pedal assembly of claim 10, wherein the recess further includes a front recess defined in the front portion and that adjoins the first and second recesses.

12. The bike pedal assembly of claim 6, wherein the illumination assembly further comprises a cover removably couplable to the body to cover the recess.

13. The bike pedal assembly of claim 1, wherein the light source comprises a light emitting diode (LED).

14. The bike pedal assembly of claim 1, wherein the illumination assembly exhibits a U-shape.

15. The bike pedal assembly of claim 1, wherein the bike pedal further includes a central portion between the first and second lateral portions and that defines a channel therethrough, and wherein the bike pedal assembly further includes a shaft assembly removably extendable within the channel and couplable a crank arm of a bike.

16. An illumination assembly, comprising:
a body, including:
a front portion;
a first arm extending from a first lateral side of the front portion and extendable through a first slot of a bike pedal; and
a second arm extending from a second lateral side of the front portion and extendable through a second slot of a bike pedal; and
a light source coupled to the body.

17. The illumination assembly of claim 16, wherein the body further includes:
a first extension extending from the first lateral side of the front portion and alongside the first arm, wherein the first tab includes a first tab extendable through a first flange slot of the bike pedal; and
a second extension extending from the first lateral side of the front portion and alongside the second arm, wherein the second extension includes a second tab extendable through a second flange slot of the bike pedal.

18. The illumination assembly of claim 16, wherein the body defines a recess and the illumination assembly further comprises:
a power source positionable in the recess and couplable to the light source;
a controller positionable in the recess and couplable to the light source and the power source.

19. The illumination assembly of claim 18, wherein:
the controller includes a port and the body defines a port aperture aligned with the port; and
the controller includes an actuator and the body defines an actuator aperture aligned with the actuator.

20. The illumination assembly of claim 18, wherein the recess includes a first recess defined in the first arm and a second recess defined in the second arm, and wherein the controller includes a first controller portion arranged in the first recess and a second controller portion arranged in the second recess.
